(19) United States
(12) Patent Application Publication
(10) Pub. No.: US 2003/0066557 A1
(43) Pub. Date: Apr. 10, 2003

(54) Safety system for mobile anhydrous ammonia fertilizer system

(76) Inventor: Bradley E. Scudder, Rockford, IL (US)

Correspondence Address: KEITH FRANTZ, 401 WEST STATE STREET, SUITE 200, ROCKFORD, IL, 61101

(21) Appl. No.: 09/973,276

(22) Filed: Oct. 9, 2001

(51) Int. Cl. F16K 17/36

(52) U.S. Cl. 137/68.14

(57) ABSTRACT

A safety system for a mobile anhydrous ammonia fertilizer application system is adapted to be remotely actuated closed by the operator in the event of a leak in the system.

### CROSS-REFERENCES TO RELATED APPLICATIONS:

none

### REFERENCE TO MICROFICHE APPENDIX FOR COMPUTER PROGRAMS:

not applicable.

### BACKGROUND OF THE INVENTION

1. Field of Invention

The present invention relates generally to safety apparatus for mobile anhydrous ammonia fertilizer systems.

More particularly the invention relates to a safety system including a safety valve provided with remote shutoff for shutting down the flow of anhydrous ammonia in the event of a leak in an anhydrous ammonia fertilizer system.

2. Description of Prior Art

Anhydrous ammonia is a widely used source of fertilizer; it is readily available and applies relatively easily. Anhydrous ammonia is also used to control mold growth in high moisture grains and to add non-protein nitrogen to corn silage.

However, anhydrous ammonia is also extremely dangerous. Among other things, anhydrous ammonia can cause damage to eyes, and to mucous membranes such as in the nose, mouth, and throat. Inhalation can also cause damage to the lining of the lungs, inhibiting oxygen transference from the lungs into the blood stream. Exposure to high concentration levels of anhydrous ammonia can even cause convulsive coughing and respiratory spasms.

As a gas, ammonia is colorless, but it has a sharp pungent odor that makes it easily detectable. When used as fertilizer, the gas is compressed into a liquid and is stored in special tanks designed to withstand the high pressure. The high pressure under which anhydrous ammonia is stored, and its caustic chemical nature, make anhydrous ammonia one of the more dangerous chemicals used in agriculture.

A typical anhydrous ammonia fertilizer system includes a high-pressure nurse tank in which the liquid anhydrous ammonia is stored and transported, a tool bar connected between the nurse tank and the back of a tractor, a set of knives extending from the tool bar into the ground for tilling the soil as the tool bar and nurse tank are pulled through a field by the tractor, a set of applicator tubes associated with the knives to dispense the anhydrous ammonia into the soil, a manifold to distribute the anhydrous ammonia to the applicator tubes, and a hose connected between the nurse tank and the manifold.

The system also typically includes a main shutoff valve connected to the nurse tank, a breakaway valve connected between the main shutoff valve and the upstream end of the hose, and a manifold shutoff valve connected between the manifold and the downstream end of the hose. The main shutoff valve is typically manually operated to control flow from the nurse tank to the distribution manifold, and the manifold shutoff valve is typically operated remotely via hydraulics to control the flow from the manifold to the applicator tubes. The breakaway shutoff valve typically consists of male and female sections that are held together such as by spring-biased ball detents. As long as the parts are together, the anhydrous ammonia will flow through unrestricted. However, if the parts separate, a spring-biased check valve will close in each section, stopping the flow therethrough.

The purpose of the breakaway valve is to automatically stop the flow of anhydrous ammonia in the event the nurse tank separates from the tractor. In this instance, as the hose pulls tight, the breakaway valve separates and shuts off the flow of anhydrous ammonia, thereby preventing a rupture in the hose itself or damage to the main valve on the nurse tank.

However, if a leak develops in the system, short of causing separation of the breakaway valve, then the system operator must manually close the main shutoff valve to stop the leak. Often times, this will require the operator to be in close proximity to the escaping anhydrous ammonia, and thus, at risk of contacting and breathing the gaseous ammonia.

For example, hoses are typically the weakest link in an anhydrous ammonia fertilizer system. They are susceptible to soft spots and cuts, ruptures and tears; and they tend to blister, bulge, crack, and slip near couplings. If the structural integrity of a hose is compromised, anhydrous ammonia will spray out. Due to the high pressure under which the liquid ammonia is under, and expansion of the ammonia as it sprays into the atmosphere, such leaks typically engulf the entire area with vaporized ammonia, causing the operator to fight his way through the cloud of vapor to reach the main shutoff valve.

And if a leak develops while fertilizing a field, the operator will need to stop the tractor, exit from the cab, and circle around the fertilizer system to reach the main shutoff valve. The time this takes results is additional hazardous ammonia being lost and sprayed into the air.

Consequently, there is a need for safety apparatus in an anhydrous ammonia fertilizer system that can be actuated closed instantly by the operator when in the tractor cab, as well as when standing or working between the cab and the nurse tank.

### SUMMARY OF THE INVENTION

The general purpose of the present invention is to provide safety apparatus for an anhydrous ammonia fertilizer system that enables the operator to quickly shut off the flow of anhydrous ammonia in the event of a hose leak.

A detailed objective of the invention is to provide a safety system comprising a shutoff valve that can be remotely actuated from inside of the tractor cab, thus permitting quick actuation of the valve to the closed position if a leak develops while working a field.

Another detailed objective is to provide such a safety system that is further adapted to be actuated closed at the valve, as well as from locations between the valve and the tractor, to enable relatively quick actuation of the valve closed regardless of where the operator may be when the leak develops.

Still another detained objective is to provide unique cable apparatus between the valve and the tractor cab for remote actuation of the valve closed.

These and other objectives and advantages of the invention will become more apparent from the following detailed description when taken in conjunction with the accompanying drawings.

Briefly, safety apparatus in accordance with the invention includes a safety shutoff valve connected in-line between the main shutoff valve on the nurse tank and the break-away valve. The safety valve is spring-biased to the closed position, and is manually cocked to the open position for normal operation of the fertilizer system.

A handle enables manual opening of the safety valve, and a latch pin automatically engages the handle to normally maintain the valve in the open position.

An actuation/release cable is connected between the pin and a release handle positioned at a convenient location in the tractor cab. The release handle, acting through the release cable, enables the operator to draw the stop pin from the valve handle, resulting in the valve automatically closing to stop the leaking anhydrous ammonia.

The release cable is provided with a shear section adapted to separate, after actuating the safety shutoff valve closed, in the event of a break-away condition between the tractor and the nurse tank.

The safety valve can be alternately closed by the operator at the valve, or at any location between the valve and the cab by simply pulling or pushing on the cable. This permits convenient closing of the valve if, for example, the operator is performing cleaning or maintenance work on of near the system.

### BRIEF DESCRIPTION OF THE DRAWINGS

FIG. 1 is a side view of a tractor and an anhydrous ammonia fertilizer system incorporating the unique aspects of the present invention.

FIG. 2 is side cross-sectional view taken longitudinally through a safety valve in accordance with the invention, and showing the valve in its open position.

FIG. 3 is a view similar to FIG. 2 but showing the valve in its closed position.

FIGS. 4 and 5 are side views of the valve shown in its open and closed positions, respectively.

FIGS. 6 and 7 are downstream end views of the valve shown in its open and closed positions, respectively.

FIGS. 8-10 are top views of the valve shown in its open position, mid-way between its open and closed position, and is closed position, respectively.

FIG. 11 is a bottom view of the valve in its closed position

FIG. 12 is an enlarged fragmentary end view with certain parts broken-away and shown in cross-section.

FIGS. 13 and 14 is an enlarged views of certain parts shown in FIG. 1, including end connections of the actuation/release cable.

FIG. 15 is a longitudinal cross-sectional view of a shear section shown in FIG. 1.

FIG. 16 is an end view of the female section shown in FIG. 15.

FIGS. 17-19 are views similar to FIG. 15 but showing progressive separation of the male and female sections thereof.

FIG. 20 is a longitudinal cross-sectional view of an alternate shear section.

FIG. 21 is a longitudinal cross-sectional view of a second alternate shear section.

Reference numerals shown in the drawings correspond to following items:

10—safety valve

12—anhydrous ammonia fertilizer system

14—tractor

16—nurse tank

18—anhydrous ammonia

20—tool bar

22—knives

24—applicator tubes

26—manifold

28—hose

30—main shutoff valve

32—breakaway valve

34—manifold shutoff valve

36—release cable

36a—intermediate end of release cable

36b—intermediate end of release cable

38a—end coupling for release cable

38b—end coupling for release cable

40—shear section

42—valve housing

44—upstream end of housing

46—downstream end of housing

48—flow passage in housing

50—ball valve element

52—spherical center

54—opening in spherical center

56—valve stem

58—flange

58a—cam surface on flange

60—handle

62—spring for ball valve

64—stop pin

64a—end of stop pin associated with flange

64b—opposite end of stop pin

66—support blocks

68—spring for stop pin

70—retaining ring

72—slot

74—crimp fitting

76—guide cone

78—release lever in tractor cab

80—release handle on valve

82—pivot pin

84—pivot pin

86—hole in flange

88—hole in housing

90—shear coupling

92—female section

94—male section

96—separable portions

98—tapered face

100a—lead-in taper

100b—lead-in taper

102—tapered face

104—alternate shear section

106—replaceable shear element

108—shear element holders

110—locking pin

112—second alternate shear section

114—male section

116—female section

118—insert

120—separable portions

122—coupling

124—annular lip

A-A—axis of rotation

While the invention is susceptible of various modifications and alternative constructions, a certain illustrated embodiment has been shown in the drawings and will be described below in detail. It should be understood, however, that there is no intention to limit the invention to the specific forms disclosed, but on the contrary, the intention is to cover all modifications, alternative constructions, and equivalents falling within the spirit and scope of the invention.

### DETAILED DESCRIPTION OF THE INVENTION

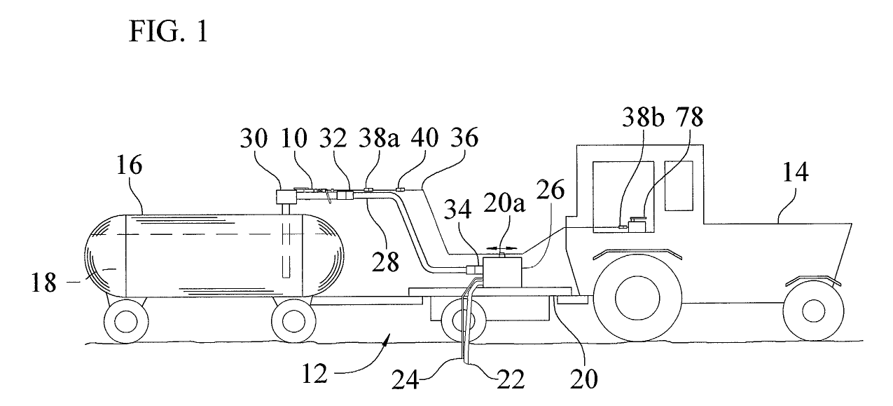

For purposes of illustration, the present invention is shown in the drawings in connection with an anhydrous ammonia fertilizer system 12 (FIG. 1) adapted to be pulled through a field by a tractor 14 that is driven by the system operator.

The anhydrous fertilizer system 12 shown includes a high-pressure nurse tank 16 in which the liquid anhydrous ammonia 18 is stored and transported, and a tool bar 20 connected between the nurse tank and the back of the tractor 14. A set of laterally spaced knives 22 extend from the tool bar into the ground for tilling the soil as the tool bar and nurse tank are pulled through a field by the tractor, and a set of applicator tubes 24 associated with the knives dispense the anhydrous ammonia into the soil. A manifold 26 carried on the toolbar receives anhydrous ammonia through a hose 28 connected to the nurse tank, and distributes the anhydrous ammonia to the applicator tubes. A main shutoff valve 30 connected to the nurse tank is manually operated to control the availability of flow from the nurse tank to the manifold. A manifold shutoff valve 34 is connected between the manifold and the downstream end of the hose, and is operated remotely via hydraulics (not shown) to control the flow from the manifold to the applicator tubes 24. A breakaway valve 32 is connected between the main shutoff valve and the upstream end of the hose, and is adapted to separate, to automatically stop the flow of anhydrous ammonia, in the event the nurse tank 16 separates from the toolbar 20.

In accordance with the present invention, a safety system is provided for remotely shutting off the flow of ammonia in the event of a leak in the fertilizer ammonia transfer system 12.

In carrying out the invention, a manually operable safety valve 10 is positioned in the fertilizer system 12 between the main shutoff valve 30 and the breakaway valve 32, and an actuation/release cable apparatus 36 extends from the safety valve to a release lever 78 in the tractor cab 14 for remote actuation of the safety valve to the closed position. Briefly, the safety valve is spring biased toward the closed position, and is manually actuated to the open position whereupon a latch mechanism acts to normally maintain the valve in the open position. The release cable is operable with the release lever in the cab, as well as from locations between the cab and the nurse tank, to release the latch mechanism such that the safety valve snaps shut.

As a result, the operator can quickly and easily shutdown the fertilizer system, and stop leaking anhydrous ammonia, thereby avoiding or limiting injury and limiting the release and loss of the anhydrous ammonia into the atmosphere.

The safety valve 10 includes a housing 42 provided with upstream and downstream threaded ends 44 and 46, respectively, for connection to couplings at the downstream end of main shutoff valve 30 and the upstream end of the breakaway valve 32, respectively, and a flow passage 48 communicating between the end couplings 44 and 46 for flow of anhydrous ammonia therethrough.

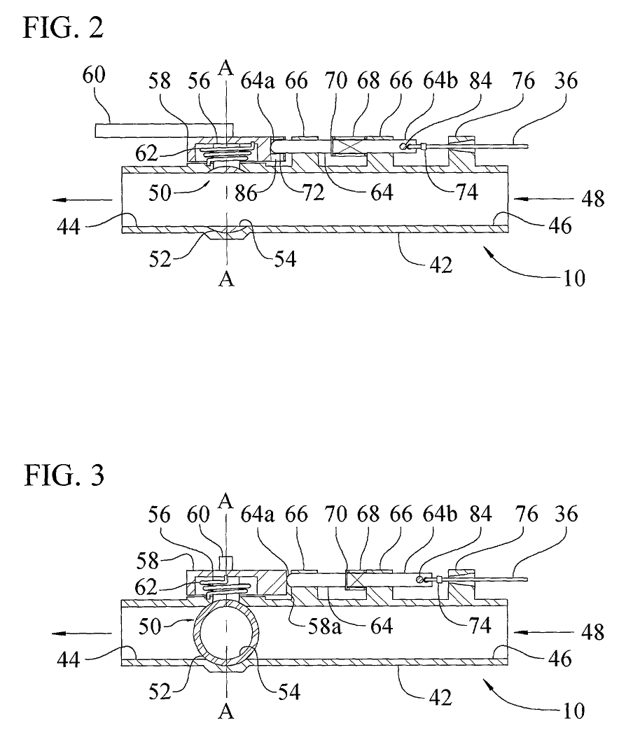

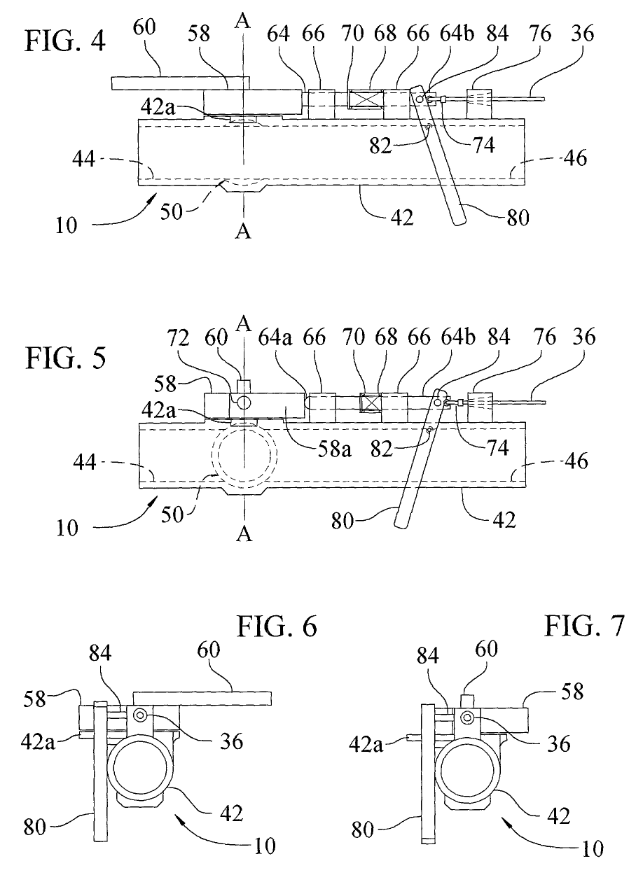

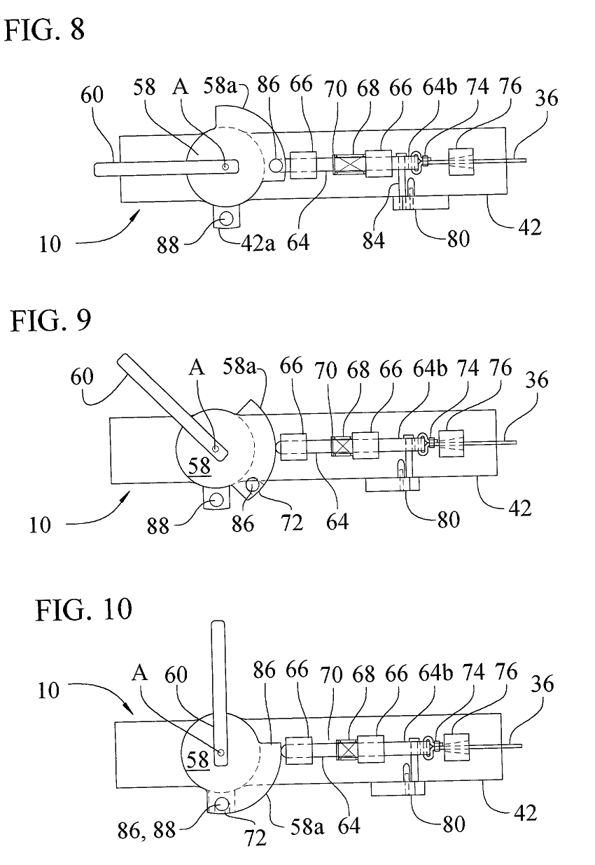

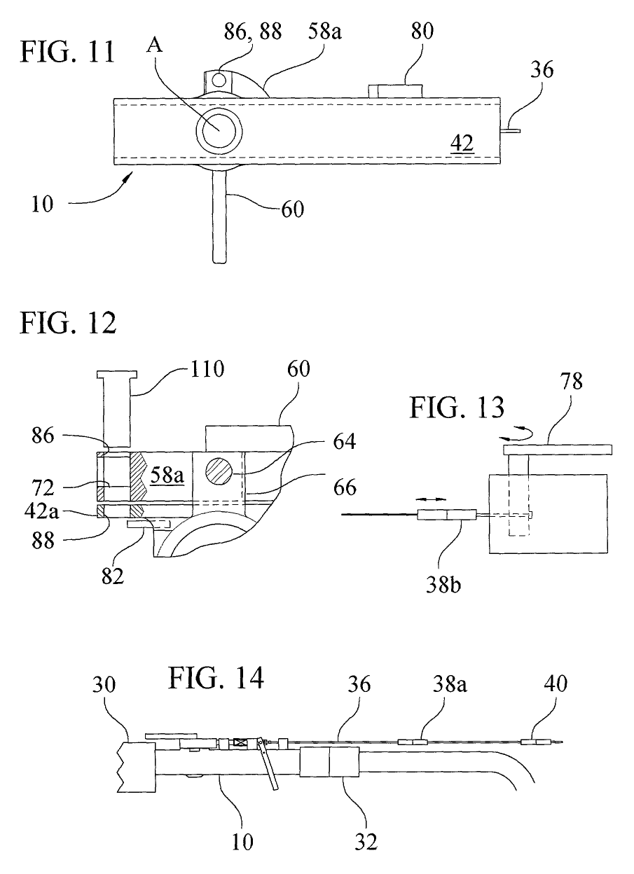

A valve element 50 is positioned in the housing 42 to open and close the flow passage 48. In the embodiment shown, the valve element is provided in the form of a ball valve that includes a spherical center 52 positioned in the flow passage 48 rotatable about axis A-A and provided with a through hole 54 extending transversely thereto. When the ball valve is positioned with the opening 54 aligned with the flow passage as shown in FIG. 2, the flow passage is open; and when the ball valve is rotated ninety degrees so that the opening 54 extends laterally as shown in FIG. 3, the flow passage is closed. In this instance, a valve stem 56 projects from the spherical center 52 through the valve housing 42, a flange 58 is connected at the free end of the valve stem, and a handle 60 is carried by the flange to enable manual rotation of the ball valve. A spring 62 operably connected between the flange and the housing biases the ball valve toward the closed position. As a result, the ball valve element is spring biased toward the closed position (FIG. 3), and can be manually actuated to the open position (FIG. 2) by grasping and turning the handle 60.

A latch mechanism carried by the housing 42 is adapted to engage the flange 58 and maintain the valve 10 in the open position. In the embodiment shown, the latch is provided in the form of a stop pin 64 slidably supported in co-axial openings, in spaced support blocks 66 that project from the housing, for movement between a “valve open” and a “valve closed” position as shown in FIGS. 2 and 3, respectively. A second spring 68 operably fitted between one of the support blocks 66 and a shoulder on the stop pin, in this instance provided by a retaining ring 70 secured to the stop pin, continuously biases the stop pin towards the flange 58.

The end 64a of the stop pin associated with the flange 58 (the left end as shown in the drawings) is sized to slip into an indentation in the housing, such as slot 72 cut into the side of the flange, and in this instance, extending radially toward the flange center axis A-A. With the valve 10 in the closed position, the end 64a of the stop pin is biased against a cam surface 58a formed on the flange, and the flange is free to be rotated. As the valve is manually turned to the open position, the stop pin rides against this cam surface until the slot 72 aligns with and opens to the axis of the stop pin, whereupon the spring 68 biases the stop pin into the slot to automatically secure the valve in the open position.

The release cable 36 is attached to the opposite end 64b of the stop pin 64 and extends through a guide cone 76 carried by the housing. In the embodiment shown, one end of the release cable extends through a cross-hole in the end 64b of the stop pin, and is clamped in position to the stop pin with a crimp-type fitting 74. As the release cable is pulled, to the right as shown in the drawings, the stop pin is drawn away from the flange 58 and is thus withdrawn from the slot 72 in the flange. The cable is slidably connected at the toolbar such as indicated at 20a (FIG. 1) for controlled location between the nurse tank and the tractor, and the other end of the cable is connected to the manual release lever 78 located in the cab of the tractor 14. The release lever is movable between two positions associated with the open and closed positions of the shutoff valve. When the manual release lever 78 is rotated or pulled from the position associated with the valve open position to the position associated with the valve closed position, the stop pin backs out of the slot, releasing the handle 58, and the spring 62 snaps the safety valve closed. The release cable may also be pushed or pulled by the operator at any location between the safety valve and the cab, causing the stop pin to be withdrawn from the flange, and the valve to automatically close.

The guide cone 76 reacts any side loading that may be applied to the cable 36, to ensure that a straight pulling action of the cable on the stop pin 64 is maintained along the axis of the pin. Alternately, for example, the cable may be supported in a simple eyelet (not shown) carried by the housing 42 to insure a straight pull.

A second handle 80 is pivotally carried by the housing 42 by pin 82 and is pivotally secured to the end 64b of the stop pin 64 with pin 84. With the valve in the open position, pulling the handle 80, to the left as shown in the drawings, withdraws the end 64a from the slot 72 whereupon the valve snaps closed. Thus, the handle 80 permits closing of the valve by the operator at the location of the valve.

To prevent inadvertent and/or unauthorized opening, the safety valve 10 preferably includes a manual lockout. In the embodiment shown, the lockout is provided in the form of the flange 58 being further provided with a through hole 86 that aligns with a hole 88 in the housing flange 42a when the valve 10 is in the closed position. This enables the operator to secure the valve closed such as with a locking pin 110 (FIG. 12) or a padlock extending through the aligned openings 86 and 88.

The release cable 36 is provided with couplings 38a, 38b, such as threaded or bayonet-type quick-connect couplings, proximate each end, and a shear or break-away section 40 at a convenient in-line location between the nurse tank 16 and the toolbar 20. The couplings provide for connection to the safety valve 10 and the release lever 78 in the cab, and for removal of the cable therefrom for ease of breakdown and storage of the fertilizer system components, to enable the release lever to be left mounted in the cab.

The shear section 40 is adapted to separate in the event of a complete break-away between the tool bar 20 and the nurse tank 16, but not until after actuating the safety valve 10 closed. More particularly, the shear section is adapted to maintain connection integrity during a predetermined pull force in the cable 36 sufficient to draw the stop pin 64 from the valve handle 58, but to then separate if the pull on the cable reaches a second predetermined higher tension. This provides a backup safety to the break-away valve 32 in the system to prevent release of ammonia.

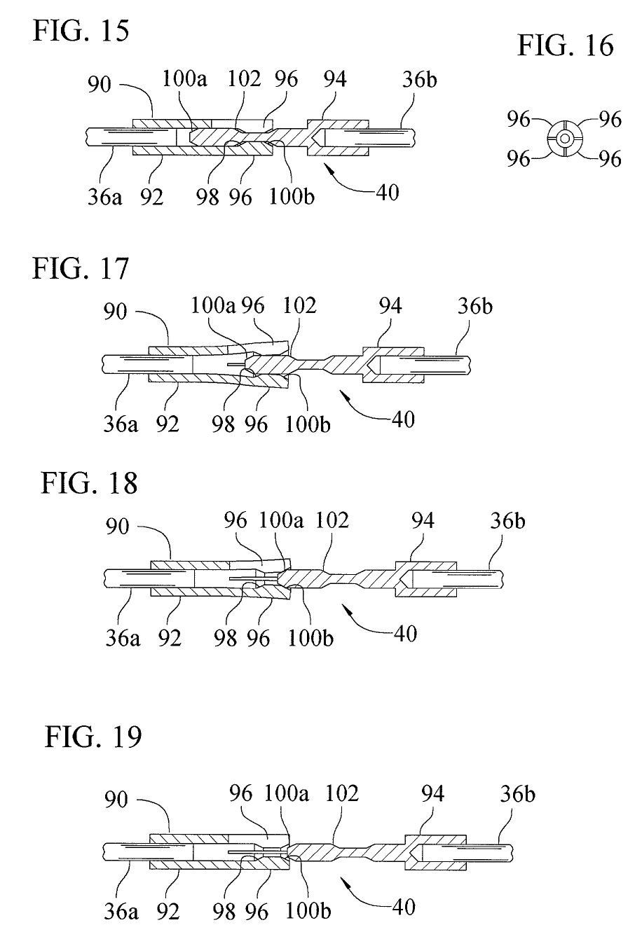

In the embodiment shown in FIGS. 15-19, the shear section 40 is provided in the form of a coupling 90 that is crimped firmly onto one intermediate end 36a of the cable 36, and that includes a female section 92 that slidably receives a male section 94 crimped firmly onto the other intermediate end 36b of the cable. In this instance, the female section is slotted into quadrant portions 96 adapted to separate during insertion and removal of the male section and to resiliently return to their normal position shown in FIGS. 15 and 19.

The female section 92 is provided with an internal tapered portion 98 facing the intermediate end 36a of the cable to which it is crimped, and the male section 94 is provided with a tapered portion 102 complimentary to and facing oppositely of the tapered portion 98 in the female section. The complimentary tapers 98 and 102 of the male and female sections then cooperate to normally maintain the male section in the female section, up to a predetermined tension in the cable 36 that is at a lever higher than the pull required to actuate the safety valve 10 closed. Thus, for example, in the event of a break-away in the hose 28, the cable actuates the safety valve closed, and then the intermediate ends of the cable separate as the male section 94 withdraws from the coupling 90 when the tension in the cable reaches the second predetermined level associated with a break-away in the fertilizer system.

The male section 94 and female section 92 are also provided with lead-in tapers 100a and 100b, respectively that cooperate to cause the split sections 96 to resiliently separate as the male section is slidably inserted therein. In the event of separation of the shear section 40 as a result of a breakaway in the system, the cable 36 is restored for use by simply re-inserting the male and female sections back together.

Those skilled in the art will appreciate that the several mechanisms and components described above are readily modified and may be provided in alternate embodiments while remaining within the scope of the present invention. For example, but without limitation, the valve element may be provided in another of the various forms of known valve elements. Suitable alternate latch or toggle arrangements are known and will be readily devised by one skilled in the art. Alternate valve actuation mechanisms such as a movable linkage arrangement may be provided in place of a conventional cable.

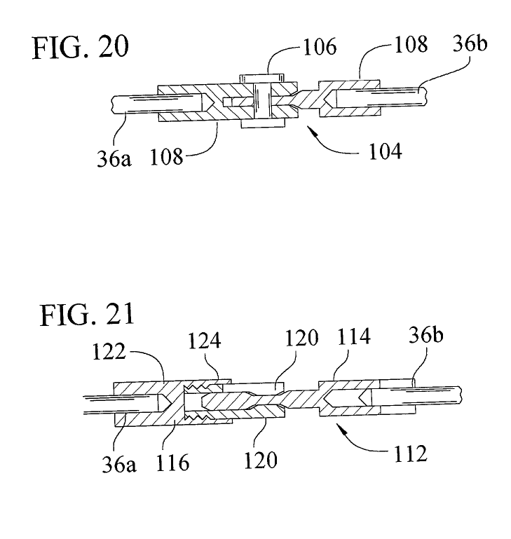

By way of further example, alternate shear sections are illustrated in FIGS. 20 and 21. The shear section 104 (FIG. 20) is provided with a replaceable shear-element 106 held transverse to the cable axis in a pair of holders 108 firmly connected to the intermediate ends of the cable. The shear section 112 (FIG. 21) is constructed with male and female sections 114 and 116 similar to shear section 40, except that in this instance, the female section includes an insert 118 provided with separable quadrant sections 120 that slidably receive the male section with a relatively low insertion force. When installed into the coupling 122, an annular lip 124 overlaps the closed-end portion of the quadrant portions 120 to provide additional holding strength, and raise the pull force that is required to withdraw the male section. The insert may be molded from a plastic-type material as an inexpensive replaceable insert (where one or more of the quadrant portions will break upon separation), or from a more resilient material for reuse following a breakaway.

From the foregoing, it will be apparent that the present invention brings to the art a new and improved safety system for anhydrous ammonia fertilizer systems, which, by virtue of alternate and remote actuation mechanisms, is uniquely adapted to enable the operator to quickly close the valve in the event of a leak in the system, thus reducing the possibility of harm to the operator from exposure to the hazardous ammonia fumes.

I claim:

1. A safety system for a mobile anhydrous ammonia fertilizer system having a nurse tank, ammonia applicator apparatus, and a flexible hose releasably coupled therebetween, the ammonia applicator apparatus being adapted for connection to a tractor for pulling the applicator apparatus and nurse tank through a field, the safety system comprising:
a) a shutoff valve connected between the nurse tank and the hose, the shutoff valve being operable between open and closed positions for allowing and preventing flow from the nurse tank to the applicator apparatus, respectively;
b) a release lever located on the tractor and movable between first and second positions associate with said shutoff valve open and closed positions;
c) a release cable connected between the shutoff valve and the release lever to enable closing of the shutoff valve with the release lever; and
d) a shear section provided in the release cable inline between the shutoff valve and the release lever for separation of the cable in the event of separation in the fertilizer system.

2. The safety system of claim 1 further comprising first and second couplings releasably connecting the ends of the cable with the shutoff valve and the release lever, respectively.

3. The safety system of claim 1 in which the cable is slidably connected to the applicator apparatus between the shutoff valve and the release lever.

4. The safety system of claim 1 in which the shutoff valve is biased toward the closed position and includes a latch to maintain the valve in the open position, the cable being connected to release the latch for automatically closing the valve.

5. The safety system of claim 1 in which the shutoff valve includes handle apparatus for manual movement of the valve between said open and closed positions.

6. The safety system of claim 1 in which the cable is flexibly exposed between the shutoff valve and the release lever for closing the valve by pulling on the cable.

7. The safety of claim 1 in which the shutoff valve includes a safety lockout.

8. The safety system of claim 1 in which the shear section includes male and female sections connected to intermediate ends of the cable and adapted for reconnection after separation.

9. The safety system of claim 1 in which the shear section includes male and female sections connected to intermediate ends of the cable, the female section further comprising a replaceable insert adapted to slidably receive the male section.
